(19) United States
(12) Patent Application Publication
(10) Pub. No.: US 2025/0272896 A1
(43) Pub. Date: Aug. 28, 2025

(54) IMAGE PROCESSING SYSTEM, INFORMATION PROCESSING METHOD, AND STORAGE MEDIUM

(71) Applicant: CANON KABUSHIKI KAISHA, Tokyo (JP)

(72) Inventor: Yo MURAKAMI, Kanagawa (JP)

(21) Appl. No.: 19/061,028

(22) Filed: Feb. 24, 2025

(30) Foreign Application Priority Data
Feb. 28, 2024 (JP) 2024-028927

(51) Int. Cl. G06T 11/60

(52) U.S. Cl. CPC G06T 11/60; G06T 2200/24

(57) ABSTRACT

There is provided with an image processing system. A first imaging parameter and a second imaging parameter of a virtual camera corresponding to a virtual viewpoint image generated based on a plurality of captured images is set, the second imaging parameter being different from the first imaging parameter. A first virtual viewpoint image is generated based on the first imaging parameter and a second virtual viewpoint image is generated based on the second imaging parameter. A composite image is generated by combining the first virtual viewpoint image and the second virtual viewpoint image. Content of operation of a user for the first imaging parameter or the second imaging parameter is obtained. The generated composite image is displayed.

### BACKGROUND

### Field

The present disclosure relates to an image processing system, an information processing method, and a storage medium.

### Description of the Related Art

In recent years, a technique in which a plurality of cameras are arranged at different positions to synchronously image a subject, a shape of an imaging target (e.g., a person) is estimated from the plurality of obtained images to generate a subject model in virtual space, and a virtual viewpoint image, the viewpoint of which can be arbitrarily changed, is generated has attracted attention. In this technique, it is also possible to generate a virtual viewpoint video (free viewpoint video) by continuously generating a virtual viewpoint image while changing the position and orientation of a virtual camera, which is a virtual viewpoint for viewing the generated model. In this technique, a subject model generated in a given frame can be represented as an afterimage by being continuously displayed for a certain period of time.

Video representation in which an afterimage is used may be useful for motion analysis or the like by being used when, for example, displaying a series of motions of a sports player at once. In addition, in an advertisement, a music video, or the like, video representation in which an afterimage of a person is displayed as an effect is used, and regarding a free viewpoint video, such a video can be generated in real time. Japanese Patent Laid-Open No. 2021-13095 describes a method of displaying, for a particular consecutively imaged subject, a virtual viewpoint image allowing comparison of instances of that particular subject, each corresponding to a different time, from a desired viewpoint.

### SUMMARY

According to one embodiment of the present invention, an image processing system comprises: one or more memories storing instructions; and one or more processors executing the instructions to: set a first imaging parameter and a second imaging parameter of a virtual camera corresponding to a virtual viewpoint image generated based on a plurality of captured images, the second imaging parameter being different from the first imaging parameter; generate a first virtual viewpoint image based on the first imaging parameter and a second virtual viewpoint image based on the second imaging parameter; generate a composite image by combining the first virtual viewpoint image and the second virtual viewpoint image; obtain content of operation of a user for the first imaging parameter or the second imaging parameter; and display the generated composite image.

According to another embodiment of the present invention, an information processing method comprises: setting a first imaging parameter and a second imaging parameter of a virtual camera corresponding to a virtual viewpoint image generated based on a plurality of captured images, the second imaging parameter being different from the first imaging parameter; generating a first virtual viewpoint image based on the first imaging parameter and a second virtual viewpoint image based on the second imaging parameter; generating a composite image by combining the first virtual viewpoint image and the second virtual viewpoint image; obtaining content of operation of a user for the first imaging parameter or the second imaging parameter; and displaying the generated composite image

According to yet another embodiment of the present invention, a non-transitory computer-readable storage medium stores a program which, when executed by a computer comprising a processor and memory, causes the computer to: set a first imaging parameter and a second imaging parameter of a virtual camera corresponding to a virtual viewpoint image generated based on a plurality of captured images, the second imaging parameter being different from the first imaging parameter; generate a first virtual viewpoint image based on the first imaging parameter and a second virtual viewpoint image based on the second imaging parameter; generate a composite image by combining the first virtual viewpoint image and the second virtual viewpoint image; obtain content of operation of a user for the first imaging parameter or the second imaging parameter; and display the generated composite image.

Further features of the present disclosure will become apparent from the following description of exemplary embodiments (with reference to the attached drawings).

### BRIEF DESCRIPTION OF THE DRAWINGS

FIG. 1 is a block diagram illustrating an example of a configuration of an image processing system according to a first embodiment.

FIG. 2 is a block diagram illustrating an example of a hardware configuration of an information processing device according to the first embodiment.

FIG. 3 is a diagram for explaining the information processing device according to the first embodiment.

FIG. 4 is a diagram for explaining a GUI of the information processing device according to the first embodiment.

FIG. 5 is a diagram for explaining virtual imaging parameter determination processing according to the first embodiment.

FIG. 6 is a block diagram illustrating an example of a functional configuration of the image processing system according to the first embodiment.

FIG. 7 is a diagram for explaining afterimage parameter determination processing according to the first embodiment.

FIG. 8 is a diagram for explaining inter-device processing according to the first embodiment.

FIG. 9 is a flowchart for explaining an example of an information processing method according to the first embodiment.

FIG. 10 is a diagram for explaining a GUI of the information processing device according to a second embodiment.

FIG. 11 is a diagram for explaining a camera path file according to a second embodiment.

FIG. 12 is a block diagram illustrating an example of a functional configuration of the system according to the second embodiment.

FIG. 13 is a flowchart for explaining an example of the information processing method according to the second embodiment.

FIG. 14 is a diagram for explaining a GUI of the information processing device according to another embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

In the method of Japanese Patent Laid-Open No. 2021-13095, subject models, each generated by imaging a subject at a different time, are continuously displayed for a certain period of time, thereby allowing afterimage representation in a free viewpoint video. In the above method, images viewed from a single virtual camera are generated and superimposed on subject models, each generated at a different time. Therefore, with the technique described in Japanese Patent Laid-Open No. 2021-13095, video representation such as that in which an afterimage is displayed so as to be slid or gradually enlarged in real time is not possible.

Embodiments of the present disclosure provide an image processing system that combines, in a virtual viewpoint image, virtual viewpoint images generated using a plurality of imaging parameters.

### First Embodiment

An image processing device included in an image processing system according to the present embodiment sets a first imaging parameter and a second imaging parameter for a virtual camera corresponding to a virtual viewpoint image generated based on a plurality of images captured by a plurality of image capturing devices. Then, the image processing device generates virtual viewpoint images, each based on respective one of these imaging parameters, and combines the virtual viewpoint images. It is assumed that a virtual viewpoint image (in particular, a foreground object therein), which has been generated based on the second imaging parameter and is to be combined with a virtual viewpoint image generated based on the first imaging parameter, will be referred to as an “afterimage” below. Further, it is assumed that a “virtual camera corresponding to a virtual viewpoint image” refers to a virtual camera that performs processing for generating (capturing) that virtual viewpoint image in virtual space.

An afterimage according to the present embodiment is a virtual viewpoint image generated based on the second imaging parameter or a part of that virtual viewpoint image, which is to be combined with a reference virtual viewpoint image. Here, the afterimage may be a virtual viewpoint image of a frame before the reference virtual viewpoint image, or may be a virtual viewpoint image that is of the same frame as the reference virtual viewpoint image but that has been generated at a different timing. By combining virtual viewpoint images thus generated, it is possible to perform afterimage representation in which images generated at different timings are simultaneously displayed in a virtual viewpoint image.

For example, the image processing device according to the present embodiment uses an imaging parameter of a virtual camera set in a first frame (reference frame), which serves as a reference, as the first imaging parameter and an imaging parameter of a virtual camera set in a second frame (past frame) before the reference frame as the second imaging parameter. In the following, the reference frame, which an afterimage is made to follow, may be referred to as the “current time” as an example.

An image processing system 10 according to the first embodiment will be described in detail below. In the present embodiment, an afterimage is rendered and displayed based on an afterimage parameter different from a real-time camera parameter inputted by a user on a GUI.

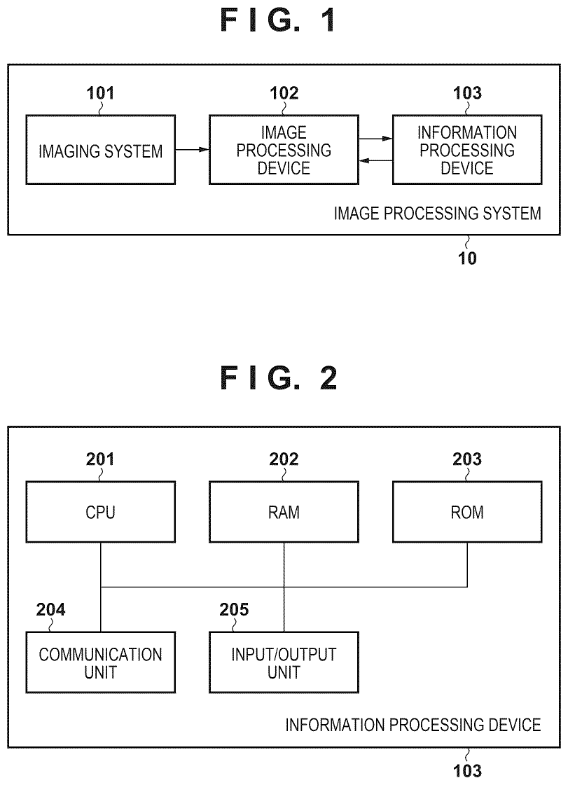

FIG. 1 is a block diagram illustrating an example of a system configuration of the image processing system 10, which generates a virtual viewpoint image and includes an image processing device 102 and an information processing device 103 according to the present embodiment. The image processing system 10 includes an imaging system 101, the image processing device 102, and the information processing device 103.

The imaging system 101 is a system that uses a plurality of image capturing devices (cameras), each arranged at a different position, surrounding an imaging region to perform imaging in which the cameras are time-synchronized. In the following, imaging that is performed by the plurality of cameras included in the imaging system 101 and in which the cameras are time-synchronized may be simply referred to as “synchronized imaging”. The imaging system 101 transmits a plurality of images that have been synchronously captured from a plurality of viewpoints to the image processing device 102. It is assumed that at this time, the plurality of images to be transmitted are transmitted via a communication medium, such as a LAN cable, for example. Here, although it is assumed that the image processing device 102 is connected to each of the imaging system 101 and the information processing device 103 so as to be capable of transmitting and receiving information, types of connections between respective apparatuses are not particularly limited. For example, each connection may be established by wired communication via the above LAN cable or the like or may be established by radio communication, or the type may be different for each connection between apparatuses. In the present embodiment, the following description will be given assuming that an imaging region in which imaging by the imaging system 101 is performed is a photography studio in which shooting for producing a virtual viewpoint image takes place, a stadium in which a sports competition takes place, a stage on which a performance takes place, or the like.

The image processing device 102 generates a virtual viewpoint image by using a technique such as model-based rendering (MBR). The processing to be performed by the image processing device 102 will be described in detail below. First, the image processing device 102 generates three-dimensional shape data of a subject based on a plurality of images synchronously captured using a plurality of cameras. In the present embodiment, the processing for “generating three-dimensional shape data of a subject” is processing for generating a group of 3D points (set of points having three-dimensional coordinates) representing a three-dimensional shape of a subject.

A method of generating three-dimensional shape data based on a plurality of images is not particularly limited, and for example, a visual hull method may be used. Here, a computer graphics (CG) model of a stadium or the like in which a group of physical cameras included in the imaging system 101 are arranged is assumed as a background model, and three-dimensional shape data of a subject is used in such a background model. It is assumed that this background model is, for example, generated in advance and stored in the image processing device 102 (e.g., stored in a ROM 203 of FIG. 2 to be described later), but may be generated, edited, or the like by, for example, a user operation. The image processing device 102 according to the present embodiment arranges three-dimensional shape data of a subject and a designated background model in the same virtual space, and thereby renders and generates a virtual viewpoint image viewed from a virtual camera. It is assumed that a parameter used for generating a virtual viewpoint image, such as the position or orientation of a virtual camera, is set as a virtual imaging parameter by the information processing device 103 in the present embodiment. With the above processing, it is possible to generate an image of three-dimensional shape data viewed from the position or line-of-sight direction of a virtual camera.

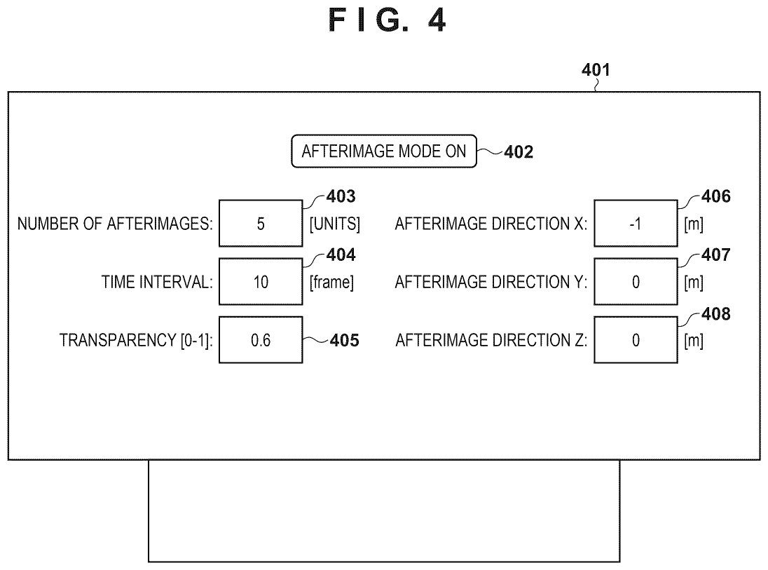

FIG. 2 is a block diagram illustrating an example of a hardware configuration of the image processing device 102. The image processing device 102 includes a CPU 201, a RAM 202, the ROM 203, a communication unit 204, and an input/output unit 205. The CPU 201 uses a control program or data stored in the RAM 202 or the ROM 203 to control the entire information processing device and control a respective function of the image processing device 102 illustrated in FIG. 4. That is, in the present embodiment, each function of the image processing device 102 is realized by the CPU 201 executing a respective program.

The RAM 202 temporarily stores a program, data, or the like read from the ROM 203. The ROM 203 holds a program or data that does not require modification. The data that does not require modification may include an imaging camera orientation parameter, a background model, or the like.

The communication unit 204 performs communication with an external device. Here, although it is assumed that the image processing device 102 is connected to each of the imaging system 101 and the information processing device 103 so as to be capable of transmitting and receiving information, types of connections used for communication between respective apparatuses are not particularly limited. For example, each connection may be established by wired communication via the above LAN cable or the like or may be established by radio communication, or the type may be different for each connection between apparatuses.

The input/output unit 205 obtains a signal inputted to the image processing device 102 and outputs an output signal to the outside. The input/output unit 205 according to the present embodiment can obtain, as an input signal, a plurality of images from the imaging system 101, an amount of operation of a controller from the information processing device 103, or a signal indicating input to an input device, and output a virtual viewpoint image generated as a processing result to a display unit of the information processing device 103.

The image processing device 102 can also have a hardware configuration similar to that of the information processing device 103 illustrated in FIG. 2. The following description will be given assuming that the image processing device 102 according to the present embodiment includes a CPU, a RAM, a ROM, a communication unit, and an input/output unit (not illustrated), similarly to the information processing device 103.

The image processing device 102 sets a first virtual imaging parameter and a second virtual imaging parameter as virtual camera imaging parameters (virtual imaging parameters). Here, the following description will be given assuming that a foreground object extracted from a virtual viewpoint image generated based on the second virtual imaging parameter is combined with a virtual viewpoint image generated based on the first virtual imaging parameter. In the following, the first virtual imaging parameter may be referred to as a “reference parameter”, and the second virtual imaging parameter may be referred to as an “afterimage parameter”. Further, a virtual camera that generates a virtual viewpoint image by using such an afterimage parameter may be referred to as an “afterimage virtual camera”.

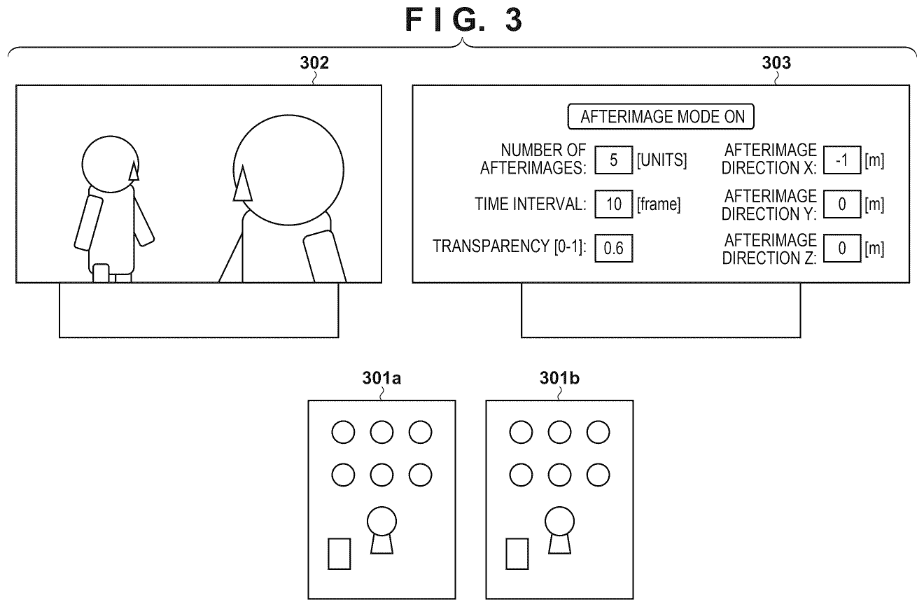

A virtual imaging parameter according to the present embodiment is a parameter for capturing a virtual viewpoint image, and includes a position parameter indicating a position of a virtual camera and an orientation parameter indicating an orientation of the virtual camera. The virtual imaging parameter includes a parameter for rendering a foreground object in virtual space. For example, the image processing device 102 according to the present embodiment may set the virtual imaging parameter based on user input obtained by the information processing device 103. The user input in the information processing device 103 will be described below with reference to FIG. 3.

FIG. 3 is a diagram for explaining an example of the information processing device 103 according to the present embodiment. The information processing device 103 according to the present embodiment is, for example, a controller, and receives an operation by a user and transmits contents of the operation as output to the image processing device 102. In the example of FIG. 3, the information processing device 103 is a controller including joysticks 301a and 301b for controlling a virtual camera, and determines a camera path representing a viewpoint of the virtual camera based on the amount of operation by the user. The joysticks 301a and 301b obtain input for a parameter (x, y, z) indicating a position of the virtual camera in three-dimensional coordinates and a pan, tilt, and roll parameter (Pan, Tilt, Roll) indicating an orientation of the virtual camera.

The input used for setting a virtual imaging parameter is not limited to only input via the joysticks 301a and 301b, and any input can be adopted so long as it can be used for setting a respective virtual imaging parameter. For example, the image processing device 102 may set a virtual imaging parameter based on input of a value by the user. In the example of FIG. 3, the information processing device 103 includes two or more display units, and includes a display unit 302 for obtaining and displaying a virtual viewpoint video generated by the image processing device 102 and a display unit 303 for displaying a GUI for inputting information related to a virtual imaging parameter. In the example of FIG. 3, a GUI for inputting respective items of a virtual imaging parameter is displayed on the display unit 303; a virtual imaging parameter will be set based on a user operation obtained via the GUI, and an afterimage will be displayed on the display unit 302.

The information processing device 103 is not particularly limited to the example illustrated in FIG. 3 so long as it is configured to similarly be capable of obtaining an amount of operation by the user. For example, the information processing device 103 may be a PC that includes a keyboard and a mouse instead of the joysticks 301a and 301b, or may be a mobile terminal such as a smartphone. Even in such a case, the information processing device 103 can display something similar to what is displayed on the display unit 302 or the display unit 303 on a display unit (e.g., an organic EL display or the like) included in the information processing device 103 or connected to the information processing device 103.

Further, in the present embodiment, a virtual imaging parameter of a virtual camera for a frame (reference frame) serving as a reference may be used as a reference parameter, and a virtual imaging parameter of a virtual camera for a frame (past frame) before the reference frame may be used as an afterimage parameter. In the present embodiment, it is assumed that the current time is used for the reference frame, and information indicating the past frame is inputted by the information processing device 103 together with information related to a virtual imaging parameter. FIG. 4 is a diagram illustrating an example of a GUI 401, which is a GUI for performing each of such input and is displayed on the display unit 303.

A button 402 is a button for switching on/off of afterimage display. An input space 403 is a field for inputting the number of afterimages to be displayed per frame for each subject, and here, it is assumed that only integers are accepted as input. The information processing device 103 obtains foreground models, the number of which corresponds to a numerical value inputted to the input space 403, and displays the foreground models as afterimages. For example, when an integer N is inputted to the input space 403, the information processing device 103 displays N pieces of foreground data as afterimages from a time code before the current time. Here, N pieces of foreground data are not necessarily foreground data at time codes of N consecutive frames counted backward from the current time. Specifically, foreground data at which a time code is to be obtained may be determined by a numerical value inputted to the input space 403 and an input space 404, which will be described later. As described above, the number of afterimages to be combined by the image processing device 102 is not limited to one, and a plurality of afterimages may be generated and combined by further using a virtual imaging parameter different from the second virtual imaging parameter. A time code according to the present embodiment is information indicating an imaging timing (timing at which a virtual viewpoint image is generated) recorded in association with a virtual viewpoint image when the virtual viewpoint image is generated by a virtual camera. Here, time codes are recorded such that the order in which respective virtual viewpoint images have been generated and frames corresponding to intervals at which virtual viewpoint images are generated are known.

The input space 404 is a field for inputting a frame interval for a time code of foreground data to be displayed as an afterimage, and here, it is assumed that only an integer is accepted as input. The information processing device 103 goes backward in frames, the number of which corresponds to a numerical value inputted to the input space 404, from the current time, and obtains a foreground model to be displayed as an afterimage. For example, when an integer I is inputted to the input space 404, the information processing device 103 displays a foreground that is I frames before the current time code as a first afterimage, a foreground that is I frames further therefrom as a second afterimage, a foreground that is I frames further therefrom as a third afterimage, and a foreground that is I frames further therefrom as . . . . When N is inputted to the input space 403, the information processing device 103 displays foregrounds up that of an N×I-th frame as afterimages. For example, when 3 is inputted to the input space 403 and 2 is inputted to the input space 404, foregrounds in frames that are 2, 4, and 6 frames counted from the current time are displayed as afterimages.

Further, the image processing device 102 according to the present embodiment can set a transparency of an afterimage to be combined. An input space 405 is a field for inputting a transparency of an afterimage. Here, it is assumed that a numerical value inputted to the input space 405 is an integer and a real number between 0.0 and 1.0. An example of processing for when actually determining a transparency of an afterimage will be described below. When a real number a is inputted to the input space 405, the information processing device 103 sets, as an alpha value of the first afterimage, a value obtained by multiplying an alpha value of a foreground at the current time by a. Further, an alpha value of each afterimage is set such that an alpha value of the second afterimage is a numerical value obtained by multiplying the alpha value of the first afterimage by a, an alpha value of a third afterimage is a numerical value obtained by multiplying the alpha value of the second afterimage by a, and an alpha value of a fourth afterimage is . . . . As described above, the image processing device 102 can set (individually for each afterimage) a transparency of display of an afterimage to be displayed in a superimposed manner. With such processing, it is possible to display afterimages with increasing transparency starting from a foreground of the current time.

In the present embodiment, an afterimage is displayed so as to follow the foreground of the current time. Therefore, a virtual camera that captures a virtual viewpoint image for displaying an afterimage also needs to move so as to follow a virtual camera at the current time. From such a viewpoint, the image processing device 102 may calculate a virtual imaging parameter (afterimage parameter) of the past frame based on a virtual imaging parameter (reference parameter) of the reference frame. For example, the image processing device 102 may set a position parameter of a virtual camera of the past frame, that is, position coordinates of a virtual camera for displaying an afterimage, to be a value obtained by adding certain offset values to coordinates of the virtual camera at the current time. Input spaces 406, 407, and 408 in FIG. 4 are fields for inputting an offset position of an afterimage virtual camera relative to the position of a virtual camera for generating a real-time image. Here, it is assumed that numerical values inputted to the input spaces 406, 407, and 408 are integers or real numbers. Such offset values may be simply referred to as an “offset of a virtual camera” below.

In this example, what are obtained by adding numerical values inputted to the input spaces 406, 407, and 408 to the coordinates of the virtual camera at the current time are the position coordinates of a virtual camera for rendering an afterimage. A specific method of determining an afterimage parameter based on numerical values inputted to the input spaces 406, 407, and 408 will be described below.

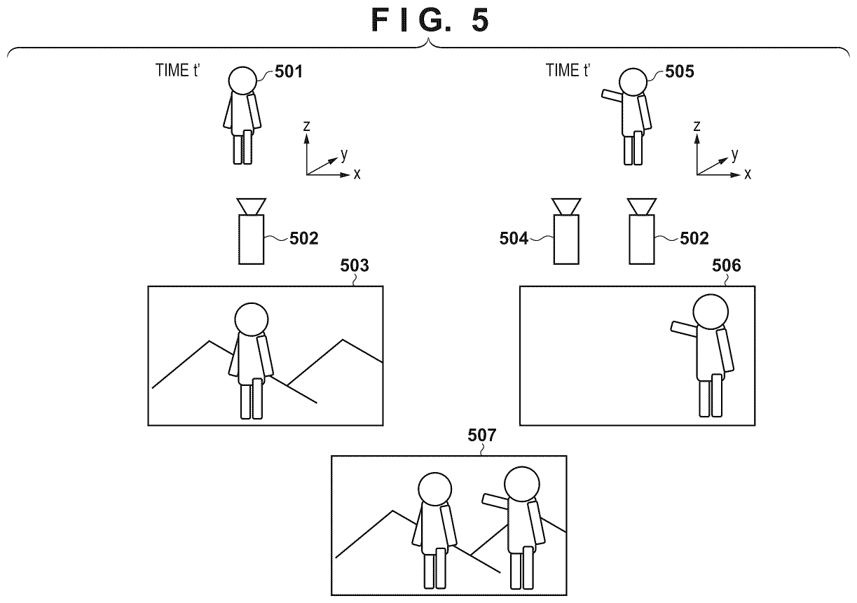

Here, a method of determining a virtual imaging parameter of a virtual camera for displaying an afterimage from a past frame as an afterimage parameter based on numerical values inputted to the input spaces 406, 407, and 408 will be described with reference to FIG. 5. FIG. 5 illustrates an example in which the user has inputted 1 in the input space 403, I in the input space 404, and (dx, dy, dz) in the input spaces 406, 407, and 408. An image 503 is a free viewpoint image (virtual viewpoint image) of a subject model 501 viewed from a position of a virtual camera 502 at a given time t. At this time, a parameter obtained by adding three-dimensional coordinate offset values (dx, dy, dz) to a virtual imaging parameter of the virtual camera 502 is assigned to an afterimage virtual camera 504. Next, the image processing device 102 uses the virtual camera 504 to render a subject model 505 at time t′, which is I frames before time t, and generates a foreground image 506. Further, the image processing device 102 combines the foreground image 506 as an after image with the image 503 by alpha blending, and generates a free viewpoint image 507 as a composite image.

As described above, the image processing device 102 combines a virtual viewpoint image generated based on an afterimage parameter with a virtual viewpoint image generated based on the reference parameter, and thereby generates a composite image. Here, as described with reference to FIG. 5, it is assumed that a foreground object extracted from a virtual viewpoint image generated based on an afterimage parameter is combined with a virtual viewpoint image generated based on the reference parameter, and thereby a composite image is generated. This foreground object compositing processing has been described here as processing for displaying a foreground object in a superimposed manner but is not particularly limited thereto so long as it is image compositing processing.

Although this concludes the description for an example of the GUI 401, embodiments of the GUI 401 are not limited to those described here. For example, a configuration may be taken so as to generate a file in which information to be inputted to the input spaces 403 to 408 is described and set an afterimage parameter by reading that file.

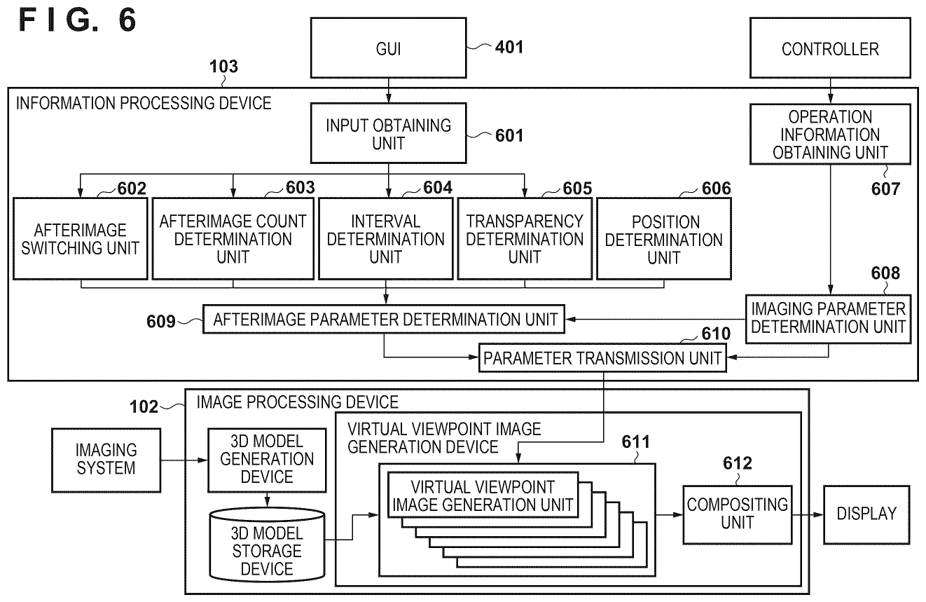

FIG. 6 is a block diagram illustrating an example of a functional configuration of the image processing device 102 and the information processing device 103 included in the image processing system 10 according to the first embodiment. The information processing device 103 according to the present embodiment accepts user input, generates the current time reference parameter and an afterimage parameter based on the obtained user input, and transmits the current time reference parameter and the afterimage parameter to the image processing device 102.

First, each functional unit included in the information processing device 103 will be described. An input obtaining unit 601 obtains information inputted on the GUI 401 by the user. The obtained information is used in an afterimage switching unit 602, an afterimage count determination unit 603, an interval determination unit 604, a transparency determination unit 605, and a position determination unit 606, which will be described later.

The afterimage switching unit 602 switches on/off of display (superimposed display) of an afterimage. Here, the afterimage switching unit 602 obtains information on whether the button 402 is on/off from the input information obtained by the input obtaining unit 601, converts the obtained information into information on display/non-display of an afterimage, and transmits the information to an afterimage parameter determination unit 609.

The afterimage count determination unit 603 determines the number of afterimages to be combined in generation of a composite image. The afterimage count determination unit 603 according to the present embodiment extracts the number of afterimages inputted to the input space 403 from the input information obtained by the input obtaining unit 601, and transmits the number of afterimages to the afterimage parameter determination unit 609.

The interval determination unit 604 obtains a frame interval for afterimages to be combined. Here, the interval determination unit 604 extracts a frame interval for afterimages inputted to the input space 404 from the input information obtained by the input obtaining unit 601, and transmits the frame interval for afterimages to the afterimage parameter determination unit 609.

The transparency determination unit 605 sets a transparency for when an afterimage is displayed in a superimposed manner. Here, the transparency determination unit 605 extracts a transparency of an afterimage inputted to the input space 405 from the input information obtained by the input obtaining unit 601, and transmits the transparency of an afterimage to the afterimage parameter determination unit 609.

The position determination unit 606 obtains information for setting a position of a virtual camera for displaying an afterimage. Here, the position determination unit 606 extracts an an offset for the position of an afterimage virtual camera inputted to the input spaces 406, 407, and 408 from the input information obtained by the input obtaining unit 601, and transmits the offset to the afterimage parameter determination unit 609.

An operation information obtaining unit 607 obtains information on a user operation. Here, the operation information obtaining unit 607 obtains operation information, such as amounts of tilt or directions of the joysticks 301a and 301b operated by the user, and transmits the operation information to an imaging parameter determination unit 608.

The imaging parameter determination unit 608 generates an imaging parameter, such as the position/orientation of a virtual camera, based on the operation information obtained from the operation information obtaining unit 607. The imaging parameter determination unit 608 transmits the generated imaging parameter to the afterimage parameter determination unit 609 and a parameter transmission unit 610.

The afterimage parameter determination unit 609 sets an afterimage parameter. Here, the afterimage parameter determination unit 609 determines an afterimage parameter according to the information obtained from the afterimage count determination unit 603, the interval determination unit 604, the transparency determination unit 605, the position determination unit 606, and the afterimage parameter determination unit 609. For example, the afterimage parameter determination unit 609 obtains information on display/non-display of an afterimage from the afterimage switching unit 602, and transmits empty information to the parameter transmission unit 610 when not displaying an afterimage. Here, when displaying an afterimage, the afterimage parameter determination unit 609 obtains the number of afterimages from the afterimage count determination unit 603, a frame interval from the interval determination unit 604, a transparency from the transparency determination unit 605, and an offset for the position of an afterimage virtual camera from the position determination unit 606. Further, the afterimage parameter determination unit 609 obtains information on the current time virtual imaging parameter from the imaging parameter determination unit 608.

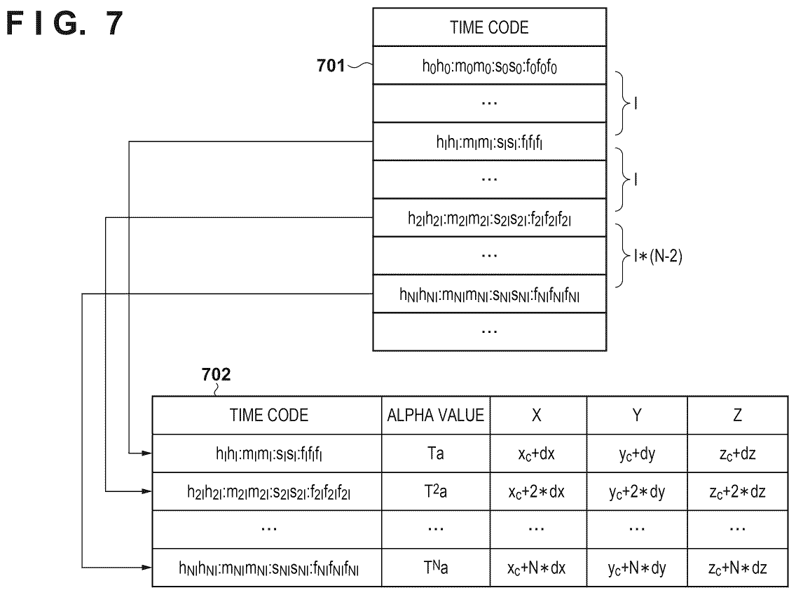

A method of determining an afterimage parameter according to the present embodiment will be described with reference to FIG. 7. In FIG. 7, a foreground alpha value is set to a and virtual camera coordinates are set to p=(xc, yc, zc) for a time code 701 of the current time. The afterimage parameter determination unit 609 determines a time code of a foreground to be displayed as an afterimage based on the number of afterimages obtained from the afterimage count determination unit 603 and the frame interval obtained from the interval determination unit 604. Here, when the number of afterimages is N and the frame interval is I, the afterimage parameter determination unit 609 obtains a time code every I frames counting from the time code 701 of the current time, with the total number of time codes corresponding to N frames.

The afterimage parameter determination unit 609 determines, for each obtained time code, an alpha value based on the transparency obtained from the transparency determination unit 605. Here, when the transparency is T, an alpha value at an n-th time code excluding the time code at the current time is a value obtained by multiplying an alpha value at an n−1-th time code by T. Therefore, the alpha value at the n-th time code is a value obtained by multiplying an alpha value a of a foreground model at the current time by Tn.

Further, the afterimage parameter determination unit 609 determines, for each obtained time code, an afterimage parameter based on an offset for the position of a virtual camera obtained from the position determination unit 606. Here, assuming that the offset is d=(dx, dy, dz), an afterimage parameter at the n-th time code is p+nd, except for the current time.

The afterimage parameter determination unit 609 generates a rendering parameter 702 having a structure in which an alpha value and an afterimage parameter at each time code for rendering an afterimage have been arranged into a set, and transmits the rendering parameter 702 to the parameter transmission unit 610. Here, in the rendering parameter 702, the time code, the alpha value, and the afterimage parameter are registered in association with each other.

The parameter transmission unit 610 obtains the reference parameter from the imaging parameter determination unit 608 and an afterimage parameter from the afterimage parameter determination unit 609. The parameter transmission unit 610 transmits the obtained virtual imaging parameters to a virtual viewpoint image generation unit 611 in the image processing device 102.

The image processing device 102 according to the present embodiment includes a virtual viewpoint image generation device, a 3D model generation device, and a 3D model storage device. The processing to be performed by the virtual viewpoint image generation device will be described below. The virtual viewpoint image generation device according to the present embodiment includes the virtual viewpoint image generation unit 611 and a compositing unit 612.

The 3D model storage device stores, in association with a time code, a virtual viewpoint image generated from a 3D model, such as the subject model 501, by using a virtual camera or a foreground object (afterimage) extracted from that virtual viewpoint image. In addition, the 3D model storage device may store a 3D model (e.g., the subject model 501) used in the present embodiment, or may store respective objects (e.g., a background model) aside from a virtual camera in virtual space, which are arranged when generating a virtual viewpoint image.

The 3D model generation device generates a respective 3D model to be stored in the 3D model storage device (generates three-dimensional shape data), and stores the 3D model in the 3D model storage device as 3D model information. Regarding generation of a 3D model, a 3D model can be generated by arbitrarily using a method of generating a 3D model in general. Further, with processing similar to that of the virtual viewpoint image generation device to be described later, the 3D model generation device can generate a virtual viewpoint image based on a 3D model and an afterimage parameter, and a foreground object extracted from the virtual viewpoint image. It is assumed that each piece of information generated by the 3D model generation device is stored in the 3D model storage device.

The virtual viewpoint image generation unit 611 obtains the current time and an afterimage parameter from the parameter transmission unit 610, and obtains 3D model information of a time code corresponding to the obtained afterimage parameter from the 3D model storage device. Here, in order to obtain a corresponding time code for each afterimage parameter, the virtual viewpoint image generation unit 611 obtains 3D model information of a plurality of time codes. For each of the plurality of obtained 3D models, a foreground image visible from a virtual camera in the position/orientation indicated by a corresponding virtual imaging parameter is rendered. Here, a plurality of 3D models are rendered in parallel by threads, the number of which corresponds to the number of obtained 3D models (=the number of obtained virtual imaging parameters). Therefore, in this example, a plurality of virtual viewpoint images are simultaneously generated. The plurality of generated virtual viewpoint images are transmitted to the compositing unit 612.

The compositing unit 612 combines a virtual viewpoint image generated based on an afterimage parameter with a virtual viewpoint image generated with the reference parameter. Here, the compositing unit 612 superimposes foregrounds of a plurality of virtual viewpoint images, which have been simultaneously generated by parallel processing and are from the virtual viewpoint image generation unit 611, and thereby generates a composite image. This compositing processing may be, for example, processing for superimposing a foreground object of a virtual viewpoint image generated based on an afterimage parameter on a virtual viewpoint image generated based on the reference parameter, or processing for superimposing foreground objects of all the virtual viewpoint images and assuming, as a composite image, what has been obtained by arranging a group of superimposed foreground objects on a background prepared in advance, and is not limited thereto.

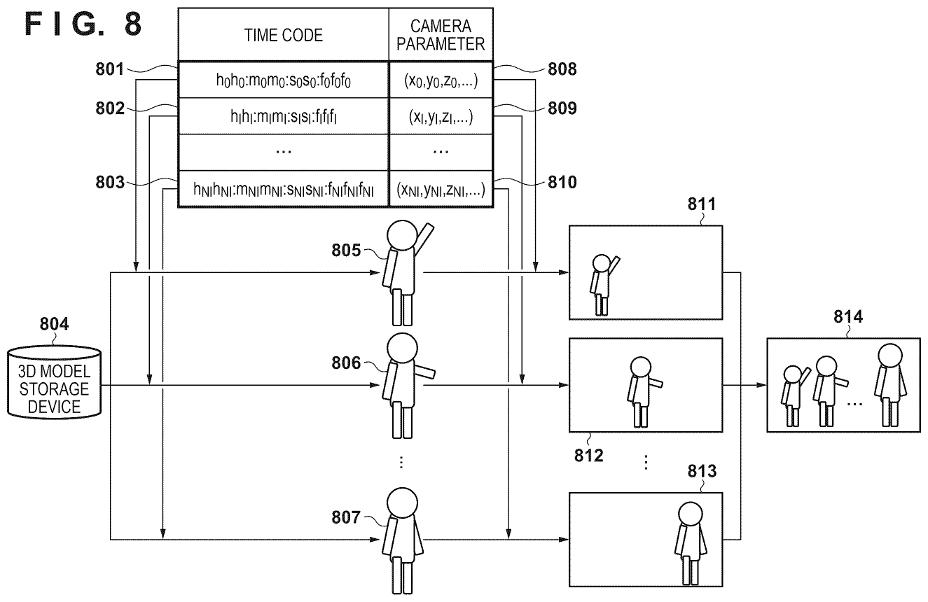

Next, the processing among the 3D model storage device, the parameter transmission unit 610, and the virtual viewpoint image generation unit 611 will be described with reference to FIG. 8. The virtual viewpoint image generation unit 611 obtains time codes for foregrounds to be displayed as afterimages from the parameter transmission unit 610. Here, a time code 801 is the current time, and time codes 802 and 803 are time codes before the time code 801. The virtual viewpoint image generation unit 611 obtains a time code every frame interval I obtained from the interval determination unit 604, with the total number of time codes being (N+1) which is obtained by adding the time code 801 and the number N of afterimages obtained from the afterimage count determination unit 603. The time code 802 is a time code that is I frames before the time code 801, and the time code 803 is a time code that is I×N frames before the time code 801.

Next, the virtual viewpoint image generation unit 611 obtains foreground 3D models 805 and 806 to 807 corresponding to the obtained time codes 801 and 802 to 803 from among foreground 3D models of a 3D model storage device 804. At the same time, the virtual viewpoint image generation unit 611 obtains virtual imaging parameters 808 and 809 to 810 corresponding to the time codes 801 and 802 to 803. Further, the virtual viewpoint image generation unit 611 generates, for respective time codes, virtual viewpoint images 811 and 812 to 813 in which 3D models 805 and 806 to 807 are rendered by using the virtual imaging parameters 808 and 809 to 810, and transmits the virtual viewpoint images 811 and 812 to 813 to the compositing unit 612.

The compositing unit 612 combines foreground images of the virtual viewpoint images 811 and 812 to 813, and generates a composite image 814. Here, superimposition is performed such that a virtual viewpoint image of a foreground captured in real time is displayed closest to the front, a virtual viewpoint image at the time code 801 is displayed therebehind, and a virtual viewpoint image at the time code 803 is displayed farthest to the back (such that those with an earlier generation timing are displayed closer to the front). This order of compositing is an example and is not limited thereto. For example, a configuration may be taken so as to obtain depth information of each virtual viewpoint image and perform compositing such that a virtual viewpoint image with a foreground closest to the virtual camera is displayed closest to the front and a virtual viewpoint image with a foreground farthest from the virtual camera is displayed farthest to the back. This depth information can be referenced by, for example, storing a distance from a virtual viewpoint to a 3D model that is calculated when generating a virtual viewpoint image and obtaining the distance at the time of compositing.

As described above, in this example, compositing in which an afterimage is extracted from all the virtual viewpoint images and these are superimposed is performed as virtual viewpoint image compositing processing. However, as described above, the virtual viewpoint image compositing processing is not limited thereto and may be, for example, processing for superimposing an afterimage generated from a virtual viewpoint image generated based on an afterimage parameter on a virtual viewpoint image (from which a foreground object has not been extracted) generated based on the reference parameter, or the like.

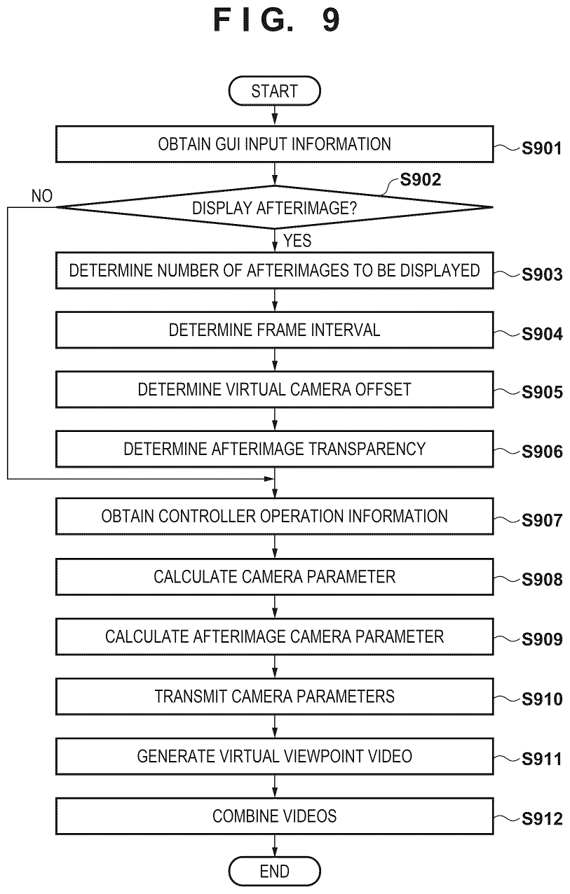

Next, a processing flow for displaying an afterimage according to the present embodiment will be described with reference to FIG. 9. FIG. 9 is a flowchart for explaining an example of afterimage display processing performed in the image processing system 10 according to the present embodiment.

In step S901, the input obtaining unit 601 obtains information inputted on the GUI 401. The input obtaining unit 601 transmits the obtained information to the afterimage switching unit 602, the afterimage count determination unit 603, the interval determination unit 604, the transparency determination unit 605, and the position determination unit 606.

In step S902, the afterimage switching unit 602 obtains information on whether the button 402 is on/off from the input information obtained by the input obtaining unit 601, converts that information into information on display/non-display of an afterimage, and transmits that information to the afterimage parameter determination unit 609.

In step S903, the afterimage count determination unit 603 obtains the number of afterimages inputted to the input space 403 from the input information obtained by the input obtaining unit 601, and transmits the number of afterimages to the afterimage parameter determination unit 609.

In step S904, the interval determination unit 604 obtains a frame interval for afterimages inputted to the input space 404 from the input information obtained by the input obtaining unit 601, and transmits the frame interval for afterimages to the afterimage parameter determination unit 609.

In step S905, the transparency determination unit 605 obtains a transparency of an afterimage inputted to the input space 405 from the input information obtained by the input obtaining unit 601, and transmits the transparency of an afterimage to the afterimage parameter determination unit 609.

In step S906, the position determination unit 606 obtains an offset for the position of an afterimage virtual camera inputted to the input spaces 406, 407, and 408 from the input information obtained by the input obtaining unit 601, and transmits the offset to the afterimage parameter determination unit 609.

In step S907, the operation information obtaining unit 607 obtains operation information, such as amounts of tilt or directions of the joysticks 301a and 301b operated by the user, and transmits the operation information to the imaging parameter determination unit 608.

In step S908, the imaging parameter determination unit 608 obtains the operation information from the operation information obtaining unit 607, converts the operation information into a virtual imaging parameter indicating the position/orientation of a virtual camera and the like, and transmits the virtual imaging parameter to the afterimage parameter determination unit 609 and the parameter transmission unit 610.

In step S909, the afterimage parameter determination unit 609 sets an afterimage parameter. Here, the afterimage parameter determination unit 609 determines an afterimage parameter according to the information obtained from the afterimage count determination unit 603, the interval determination unit 604, the transparency determination unit 605, the position determination unit 606, and the afterimage parameter determination unit 609. For example, the afterimage parameter determination unit 609 obtains information on display/non-display of an afterimage from the afterimage switching unit 602, and transmits empty information to the parameter transmission unit 610 when not displaying an afterimage. Here, when displaying an afterimage, the afterimage parameter determination unit 609 obtains the number of afterimages from the afterimage count determination unit 603, a frame interval from the interval determination unit 604, a transparency from the transparency determination unit 605, and an offset for the position of an afterimage virtual camera from the position determination unit 606. Further, the afterimage parameter determination unit 609 obtains information on the current time virtual imaging parameter from the imaging parameter determination unit 608.

In step S910, the parameter transmission unit 610 transmits the reference parameter determined by the imaging parameter determination unit 608 and the afterimage parameter determined by the afterimage parameter determination unit 609 to the virtual viewpoint image generation unit 611 included in the image processing device 102.

In step S911, the virtual viewpoint image generation unit 611 obtains the reference parameter and the afterimage parameter from the parameter transmission unit 610. The virtual viewpoint image generation unit 611 obtains, for the obtained virtual imaging parameters, 3D model information of corresponding time codes from the 3D model storage device. Then, the virtual viewpoint image generation unit 611 renders, for each of the plurality of obtained 3D models, a foreground image visible from the virtual camera in the position and orientation indicated by the corresponding virtual imaging parameter. Here, it is assumed that a foreground object portion of an image captured by a virtual camera is generated as a virtual viewpoint image. A plurality of generated virtual viewpoint images are transmitted to the compositing unit 612.

In step S912, the compositing unit 612 superimposes foregrounds of a plurality of virtual viewpoint images simultaneously generated by parallel processing from the virtual viewpoint image generation unit 611, and thereby generates a composite image. With the above processing, a composite image on which a foreground object of a virtual viewpoint image of a past frame is superimposed as an afterimage is generated.

In the present embodiment, an example in which a virtual imaging parameter is managed for each time code, and an afterimage is rendered based on such a virtual imaging parameter (based on a parameter different from the real-time camera parameter) and displayed has been described. According to such processing, it is possible to display an afterimage that does not depend on a parameter of the virtual camera at the current time. Therefore, even when, for example, a foreground subject is still, it is possible to impart an effect in which afterimage representation is used, such as an afterimage being displayed so as to slide in a horizontal direction in real time.

In the present embodiment, description has been given assuming that respective processes such as those indicated in the processing of FIG. 9 are performed by the information processing device 103 and the image processing device 102 in cooperation with each other. However, so long as similar processing can be executed, the present invention is not particularly limited thereto, and for example, a configuration may be taken such that the information processing device 103 includes functional units having functions similar to those of the image processing device 102 and the image processing device 102 includes an input unit and a display unit and performs some or all of the respective functions described to be performed by the information processing device 103.

### Second Embodiment

In the first embodiment, an example in which the position of a virtual camera for displaying an afterimage is calculated from an x value, a y value, and a z value in three-dimensional coordinates inputted on a GUI and an afterimage is rendered has been described. In the processing described in the first embodiment, afterimage virtual cameras are arranged on a straight line from the virtual camera at the current time. Meanwhile, in a second embodiment, a form in which a camera path file indicating a trajectory of afterimage virtual cameras is taken as input and the afterimage virtual cameras are arranged on an arbitrary trajectory in virtual space will be described.

An information processing device 1203 according to the second embodiment takes, as virtual camera coordinates included in a virtual imaging parameter, input of a camera path file describing relative parameters of all the afterimage virtual cameras relative to a virtual imaging parameter of a real-time image. With this, it is possible to display afterimages not only on a straight line, but also on a curve, for example.

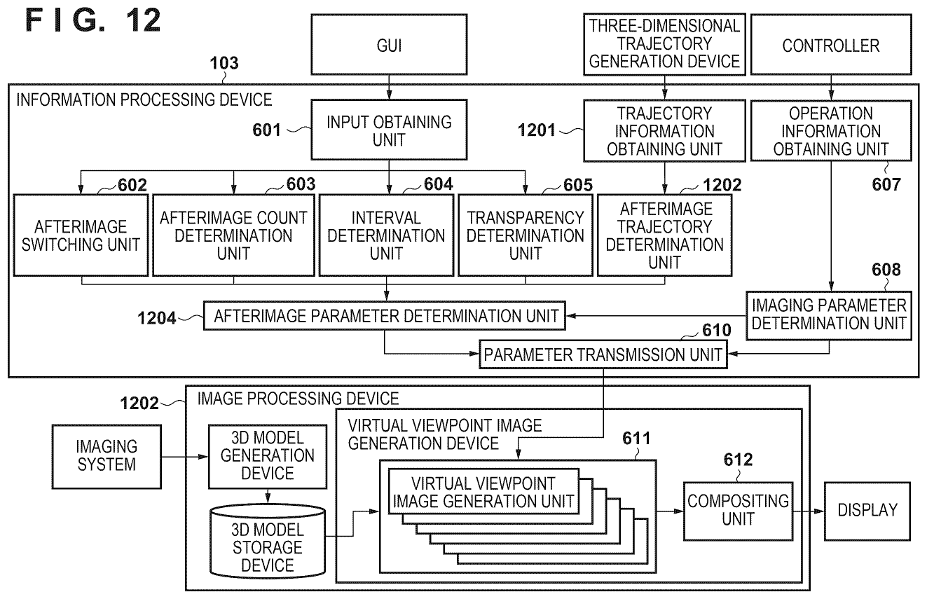

An image processing device 1202 and the information processing device 1203 according to the present embodiment have functions similar to those of the image processing device 102 and the information processing device 103 according to the first embodiment, respectively, and can execute similar processing. Differences in functional units from the image processing device and the information processing device of the first embodiment will be described later with reference to FIG. 12.

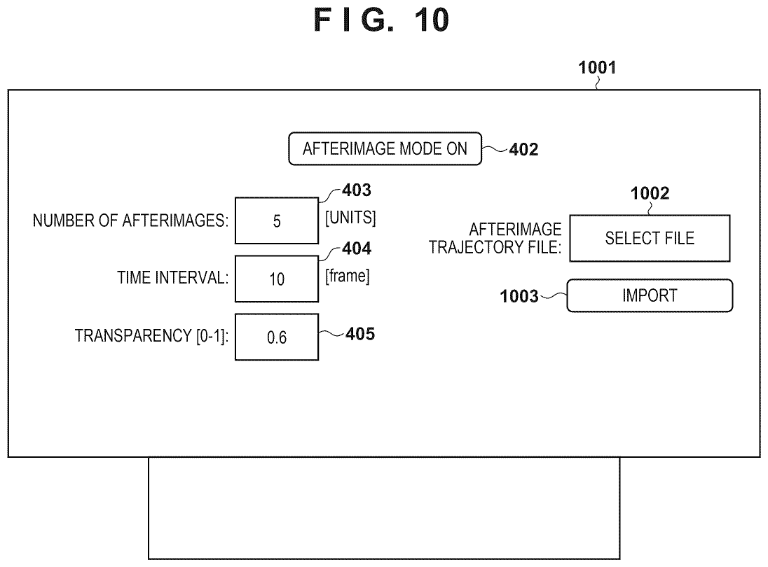

FIG. 10 is a diagram illustrating an example of a GUI 1001 to be displayed on the display unit 303 according to the present embodiment. Information to be inputted via the GUI 1001 and respective processes to be executed accordingly will be described below. Among those illustrated in FIG. 10, those having functions similar to those in the GUI 401 of FIG. 4 are denoted by the same reference numerals, and redundant description will be omitted.

An input space 1002 is a field for inputting a path for a camera path file representing a trajectory of a virtual camera for rendering an afterimage. The user inputs a camera path file into the input space 1002 and clicks a button 1003. With this operation, the information processing device 1203 obtains information on the camera path file.

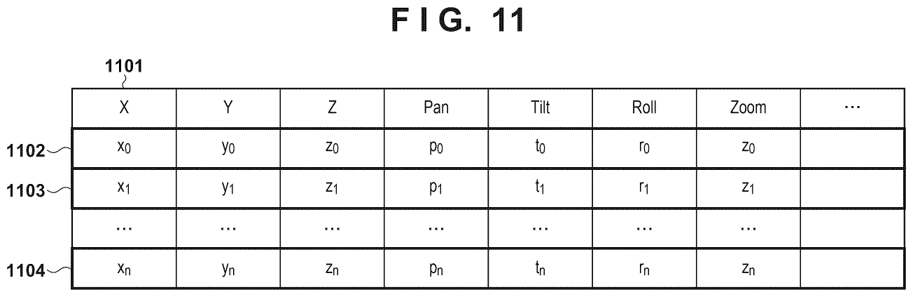

FIG. 11 illustrates an example of a file structure of a camera path file 1101 to be inputted to the input space 1002. The camera path file 1101 is represented by, for example, a table as seen in FIG. 11. In the present embodiment, an afterimage virtual camera moves so as to follow the real-time virtual camera as in the first embodiment. Therefore, an afterimage parameter is represented as a parameter obtained by adding a parameter (offset value) relative to the real-time virtual imaging parameter (reference parameter). In the example of FIG. 11, such offset values are stored as description, starting from the second line of the camera path file 1101. Here, when N is inputted to the input space 403 and I is inputted to the input space 404 on the GUI 1001, a virtual imaging parameter 1102 in the second row is an offset value for an afterimage virtual camera for rendering a foreground that is I frames counted from the current time code. In addition, a virtual imaging parameter 1103 in the third row is an offset value for an afterimage parameter for rendering a foreground that is 2×I frames counted from the current time code. A virtual imaging parameter 1104 in an n-th row is an offset value for an afterimage parameter for rendering a foreground that is (n−1)×I frames counted from the current time code.

Here, a virtual imaging parameter includes (x, y, z) representing coordinates of a virtual camera in three-dimensional space and (Pan, Tilt, Roll) representing an orientation of the virtual camera, and a zoom value Zoom. It is assumed that if the number of offsets for afterimage virtual camera parameters described in the camera path file 1101 does not match the number N of afterimages to be displayed, the number of offsets described in the camera path file 1101 will be the number of afterimages to be actually displayed. This is an example, and a method of determining the number of afterimages is not limited thereto. For example, a configuration may be taken so as to compare the number N of afterimages and the number of offsets and set a smaller numerical value as the number of afterimages. Further, for example, a configuration may be taken so as to assume the number N of afterimages as the number of offsets. If such a method is assumed, the image processing device 102 interpolates offset values, which are discrete values, and performs conversion into continuous values connecting the first offset value and the last offset value. Then, the image processing device 102 obtains values at equal intervals as many as the number N of afterimages, and sets the values as new offset values. This concludes the description of an example of the file structure of the camera path file 1101. The structure of the camera path file 1101 is not limited to such a form so long as offset values can be similarly set.

Further, the image processing device 102 may set, as an afterimage parameter, a value obtained by adding a camera parameter described in the camera path file 1101 to the parameter of the real-time virtual camera. According to such processing, an afterimage virtual camera moves so as to follow the real-time virtual camera, and an afterimage can be displayed so as to follow a real-time foreground in an image to be outputted.

Next, a functional configuration of the image processing device 1202 and the information processing device 1203 included in the image processing system according to the present embodiment will be described with reference to FIG. 12. FIG. 12 is a block diagram illustrating an example of a functional configuration of the image processing device 1202 and the information processing device 1203 included in the image processing system according to the second embodiment. The information processing device 1203 according to the present embodiment accepts user input, generates the current time reference parameter and an afterimage parameter based on the obtained user input, and transmits the current time reference parameter and the afterimage parameter to the image processing device 102. Among components illustrated in FIG. 12, those similar to those illustrated in FIG. 6 of the first embodiment are denoted by the same reference numerals, and redundant description will be omitted.

A trajectory information obtaining unit 1201 reads a file path for a camera path file described by the user in the input space 1002 on the GUI 1001, and obtains information on a three-dimensional trajectory generation file as illustrated in the example of the camera path file 1101. The obtained file information is transmitted to an afterimage trajectory determination unit 1202.

The afterimage trajectory determination unit 1202 obtains file information from the trajectory information obtaining unit 1201 and reads described information. The afterimage trajectory determination unit 1202 obtains virtual imaging parameters, such as the positions or directions of virtual cameras, from a file, and sets the virtual imaging parameters as offset values for virtual camera parameters for rendering an afterimage. This group of offset values are transmitted to an afterimage parameter determination unit 1204.

The afterimage parameter determination unit 1204 sets an afterimage parameter. Here, the afterimage parameter determination unit 1204 determines an afterimage parameter according to the information obtained from the afterimage count determination unit 603, the interval determination unit 604, the transparency determination unit 605, and the afterimage trajectory determination unit 1202. For example, the afterimage parameter determination unit 1204 obtains information on display/non-display of an afterimage from the afterimage switching unit 602, and transmits empty information to the parameter transmission unit 610 when not displaying an afterimage. Here, when displaying an afterimage, the afterimage parameter determination unit 1204 obtains the number of afterimages from the afterimage count determination unit 603, a frame interval from the interval determination unit 604, a transparency from the transparency determination unit 605, and a group of offsets for afterimage parameters from the afterimage trajectory determination unit 1202. Further, the afterimage parameter determination unit 1204 obtains information on the current time camera parameter from the imaging parameter determination unit 608.

Here, it is assumed that when the number of afterimages obtained from the afterimage count determination unit 603 and the number of offsets for afterimage virtual camera parameters obtained from the afterimage trajectory determination unit 1202 do not match, the number of afterimages is assumed as the number of offsets for virtual imaging parameters. This is an example, and a method of determining the number of afterimages is not limited thereto. For example, a configuration may be taken so as to compare the number of afterimages obtained from the afterimage count determination unit 603 with the number of offsets obtained from the afterimage trajectory determination unit 1202 and set a smaller numerical value as the number of afterimages. Further, for example, a configuration may be taken so as to assume the number of afterimages as the number of offsets. If such a method is assumed, the image processing device 102 interpolates offset values, which are discrete values, and performs conversion into continuous values connecting the first offset value and the last offset value. Then, the image processing device 102 obtains values at equal intervals as many as the number N of afterimages, and sets the values as new offset values.

The afterimage parameter determination unit 1204 generates a rendering parameter having a structure in which an alpha value and a virtual imaging parameter at each time code for rendering an afterimage have been arranged into a set, and transmits the rendering parameter to the parameter transmission unit 610.

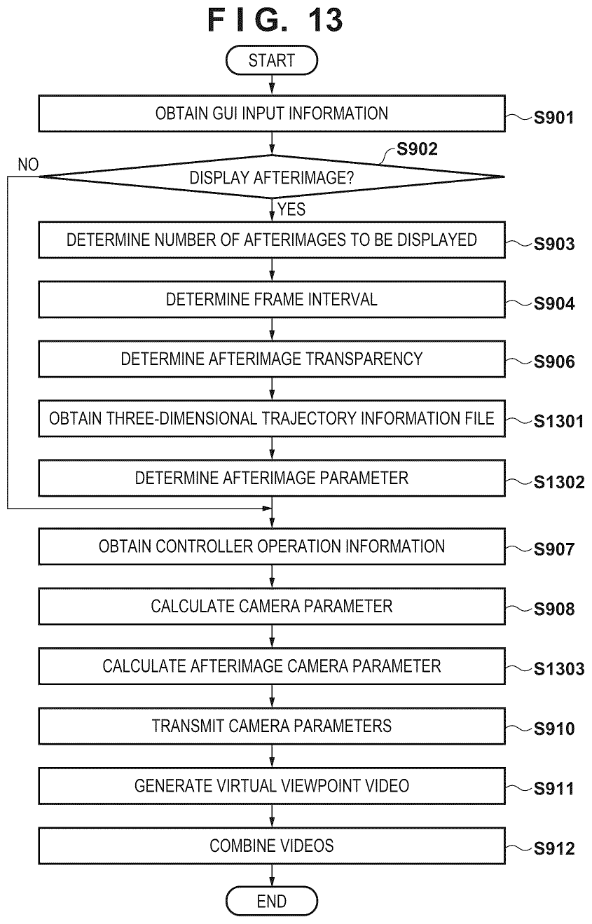

Next, a processing flow for displaying an afterimage according to the present embodiment will be described with reference to FIG. 13. FIG. 13 is a flowchart for explaining an example of afterimage display processing performed in the image processing system according to the present embodiment. The processing according to FIG. 13 is similar to that illustrated in FIG. 9 except that steps S1301 and S1302 are performed between steps S906 and S907 and step S1303 is performed instead of step S909, and thus, redundant explanation will be omitted.

In step S1301, the trajectory information obtaining unit 1201 obtains information on a three-dimensional trajectory generation file as indicated in the example of the camera path file 1101. The obtained file information is transmitted to the afterimage trajectory determination unit 1202.

In step S1302, the afterimage trajectory determination unit 1202 obtains file information from the trajectory information obtaining unit 1201 and reads described information. The afterimage trajectory determination unit 1202 obtains a virtual imaging parameter, such as the position or orientation of a virtual camera, from a file, and sets the virtual imaging parameter as a virtual imaging parameter for rendering an afterimage. The afterimage trajectory determination unit 1202 transmits a group of camera parameters, which are virtual imaging parameters of a plurality of frames, to the afterimage parameter determination unit 1204.

In step S1303, the afterimage parameter determination unit 1204 sets an afterimage parameter. Here, the afterimage parameter determination unit 1204 determines an afterimage parameter according to the information obtained from the afterimage count determination unit 603, the interval determination unit 604, the transparency determination unit 605, and the afterimage trajectory determination unit 1202. For example, the afterimage parameter determination unit 1204 obtains information on display/non-display of an afterimage from the afterimage switching unit 602, and transmits empty information to the parameter transmission unit 610 when not displaying an afterimage. Here, when displaying an afterimage, the afterimage parameter determination unit 1204 obtains the number of afterimages from the afterimage count determination unit 603, a frame interval from the interval determination unit 604, a transparency from the transparency determination unit 605, and a group of offsets for afterimage parameters from the afterimage trajectory determination unit 1202. Further, the afterimage parameter determination unit 1204 obtains information on the current time camera parameter from the imaging parameter determination unit 608. Further, the afterimage parameter determination unit 1204 generates a rendering parameter having a structure in which an alpha value and a virtual imaging parameter at each time code for rendering an afterimage have been arranged into a set, and transmits the rendering parameter to the parameter transmission unit 610.

In the present embodiment, a method in which a three-dimensional trajectory generation file is taken as input and a virtual imaging parameter of a virtual camera for rendering an afterimage is determined has been described. According to such processing, it is possible to display afterimages of foregrounds on an arbitrary trajectory in three-dimensional space. Thus, it is possible to display afterimages not only on a straight line, but also on a curve, for example.

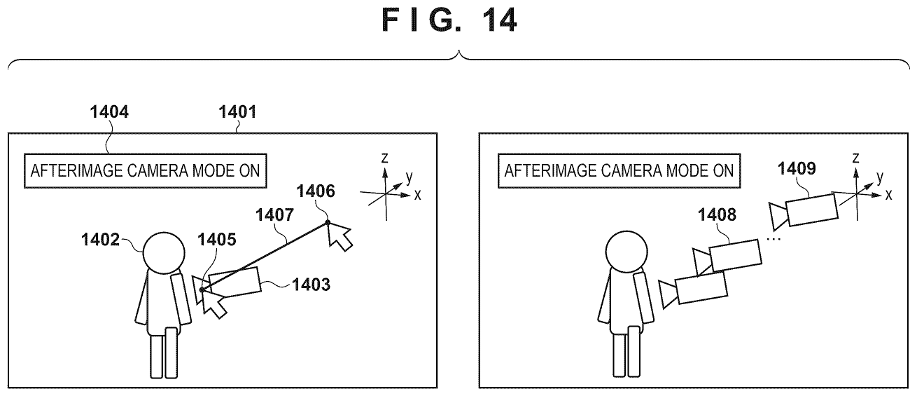

In the first and second embodiments, a configuration in which input of a numerical value by the user to an input space on the GUI 401 or the GUI 1001 is accepted, and a parameter for displaying an afterimage is determined based on such input has been described. However, the form of a GUI is not limited thereto. An example of a GUI different from those in the first and second embodiments will be described below with reference to FIG. 14.

FIG. 14 illustrates a display unit 1401, which displays three-dimensional virtual space and is different from the GUI 401, the GUI 1001, and the display unit 302. In the example of FIG. 14, a simple dummy 3D model 1402 simulating an actual subject and a camera model 1403 indicating a virtual camera of a real-time video are already displayed on the display unit 1401. The user can view the 3D model 1402 and the camera model 1403 from any position and orientation. Further, here, it is assumed that the 3D model 1402 and the camera model 1403 can be freely arranged and moved by a user operation. The 3D model 1402 and the camera model 1403 are moved based on an operation (e.g., drag & drop on the model) of a mouse. Further, the viewpoint can be moved from an arbitrary position other than the model in the window by, for example, drag & drop.

Operations and processing for when determining an offset value for an afterimage virtual camera will be described below. The user first presses a button 1404. With this operation, display of the display unit 1401 is switched from a mode for moving the viewpoint and a model based on behavior during a mouse operation to a mode for determining a parameter of a virtual camera based on behavior during a mouse operation. After pressing the button 1404, the user drags and drops the camera model 1403 from a position 1405 as the starting point to an arbitrary position 1406. During the mouse operation, a trajectory 1407 is displayed in three-dimensional space. When the mouse is released, camera models 1408 to 1409, the number of which matches the number of afterimages inputted to the input space 403 on the GUI 401 or the GUI 1001, are displayed at equal intervals. In this example, these camera models 1408 to 1409 are virtual cameras for rendering an afterimage. The trajectory 1407 is a trajectory of movement of camera models, and is drawn in three-dimensional virtual space. By changing the viewpoint position of a virtual camera, it is possible to change the depth or the like. When positions of camera models are determined, the button 1404 is pressed again to switch from the mode for determining a virtual imaging parameter to the mode for moving the viewpoint and a model. The positions of the plurality of virtual camera models thus determined are set as relative positions (offset values) of afterimage virtual cameras relative to the real-time virtual camera.

According to such a configuration, in the virtual viewpoint image displayed on the display unit 302, a virtual camera for rendering an afterimage continues to follow the real-time virtual camera while maintaining a relative position determined by an operation on the display unit 1401. Then, the user can adjust the positions of a plurality of camera models while confirming the virtual viewpoint image displayed on the display unit 302. Further, it is possible to finely adjust an afterimage virtual camera by an operation for moving an arbitrary camera model of the camera models 1408 to 1409 on the display unit 1401 while viewing the display unit 302. As described above, instead of directly inputting a numerical value, the user draws a trajectory of afterimage virtual cameras and generates a path, and thereby, it becomes easier for the user to intuitively ascertain on what trajectory a group of virtual cameras are arranged. This has an advantage that it is possible to roughly predict how a subject and its afterimage will appear in an actually generated video rather than inputting a numerical value.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-028927, filed Feb. 28, 2024, which is hereby incorporated by reference herein in its entirety.

What is claimed is:

1. An image processing system comprising:
one or more memories storing instructions; and
one or more processors executing the instructions to:
set a first imaging parameter and a second imaging parameter of a virtual camera corresponding to a virtual viewpoint image generated based on a plurality of captured images, the second imaging parameter being different from the first imaging parameter;
generate a first virtual viewpoint image based on the first imaging parameter and a second virtual viewpoint image based on the second imaging parameter;
generate a composite image by combining the first virtual viewpoint image and the second virtual viewpoint image;
obtain content of operation of a user for the first imaging parameter or the second imaging parameter; and
display the generated composite image.

2. The image processing system according to claim 1, wherein
the first imaging parameter is an imaging parameter of the virtual camera for a first frame, and the second imaging parameter is an imaging parameter of the virtual camera for a second frame before the first frame.

3. The image processing system according to claim 2, wherein the one or more processors further execute the instructions to:
set an interval between the first frame and the second frame.

4. The image processing system according to claim 3, wherein
the interval between the first frame and the second frame is set based on user input.

5. The image processing system according to claim 1, wherein
the composite image is generated by combining a foreground object extracted from the second virtual viewpoint image into the first virtual viewpoint image.

6. The image processing system according to claim 5, wherein
the composite image is an image in which the foreground object is displayed in a superimposed manner on the first virtual viewpoint image, and
the one or more processors further execute the instructions to switch superimposed display of the foreground object in the composite image on/off.

7. The image processing system according to claim 6, wherein
superimposed display of the foreground object is switched on/off based on user input.

8. The image processing system according to claim 5, wherein
the second imaging parameter includes a parameter for rendering the foreground object in the virtual viewpoint image.

9. The image processing system according to claim 5, wherein the one or more processors further execute the instructions to:
set a position in which the foreground object is displayed in a superimposed manner in the first virtual viewpoint image.

10. The image processing system according to claim 1, wherein the one or more processors further execute the instructions to:
obtain user input; and
set the second imaging parameter based on the first imaging parameter and the user input.

11. The image processing system according to claim 1, wherein the one or more processors further execute the instructions to:
set a predetermined number of imaging parameters different from the first imaging parameter and the second imaging parameter;
generate virtual viewpoint images, each based on a respective one of the predetermined number of imaging parameters; and
generate a composite image by combining the virtual viewpoint images, each based on a respective one of the predetermined number of imaging parameters, in addition to the first virtual viewpoint image and the second virtual viewpoint image.

12. The image processing system according to claim 11, wherein
the predetermined number is set based on user input.

13. The image processing system according to claim 1, wherein the one or more processors further execute the instructions to:
set a transparency of the second virtual viewpoint image at which combining for the composite image is performed.

14. The image processing system according to claim 1, wherein
the second imaging parameter includes information indicating a position of the virtual camera in virtual space for generating the second virtual viewpoint image.

15. The image processing system according to claim 14, wherein
the information indicating the position of the virtual camera in virtual space for generating the second virtual viewpoint image is information indicating a trajectory of the virtual camera.

16. The image processing system according to claim 1, wherein the one or more processors further execute the instructions to
present the generated composite image; and
obtain content of operation of the user for the first imaging parameter and the second imaging parameter.

17. The image processing system according to claim 16, wherein
the first imaging parameter or the second imaging parameter are set based on the content of operation.

18. An information processing method comprising
setting a first imaging parameter and a second imaging parameter of a virtual camera corresponding to a virtual viewpoint image generated based on a plurality of captured images, the second imaging parameter being different from the first imaging parameter;
generating a first virtual viewpoint image based on the first imaging parameter and a second virtual viewpoint image based on the second imaging parameter;
generating a composite image by combining the first virtual viewpoint image and the second virtual viewpoint image;
obtaining content of operation of a user for the first imaging parameter or the second imaging parameter; and
displaying the generated composite image

19. A non-transitory computer-readable storage medium storing a program which, when executed by a computer comprising a processor and memory, causes the computer to:
set a first imaging parameter and a second imaging parameter of a virtual camera corresponding to a virtual viewpoint image generated based on a plurality of captured images, the second imaging parameter being different from the first imaging parameter;
generate a first virtual viewpoint image based on the first imaging parameter and a second virtual viewpoint image based on the second imaging parameter;
generate a composite image by combining the first virtual viewpoint image and the second virtual viewpoint image;
obtain content of operation of a user for the first imaging parameter or the second imaging parameter; and
display the generated composite image.
